(19) United States
(12) Patent Application Publication
(10) Pub. No.: US 2011/0262699 A1
(43) Pub. Date: Oct. 27, 2011

(54) LOW-EMISSIVITY STRUCTURES

(75) Inventors: Angelo Yializis, Tucson, AZ (US); Gordon Goodyear, Tucson, AZ (US); Steven Yializis, Tucson, AZ (US)

(73) Assignee: Sigma Laboratories of Arizona, LLC., Tucson, AZ (US)

(21) Appl. No.: 13/175,865

(22) Filed: Jul. 3, 2011

Related U.S. Application Data
(63) Continuation-in-part of application No. 12/250,083, filed on Oct. 13, 2008.

(51) Int. Cl. E04B 1/94; E04B 1/62; B32B 5/18; B32B 3/10; B32B 15/04; B32B 27/06

(52) U.S. Cl. 428/138; 428/469; 428/315.9; 428/318.4; 442/230; 442/316; 442/379; 428/314.4; 428/201; 428/319.3; 428/216

(57) ABSTRACT

A multilayer radiant-barrier structure is formed on one or both sides of a substrate that can be attached to an insulating layer to produce a reflective insulating material. The metallized layer is protected from environmental degradation without interfering with flammability properties that are critical for radiant and reflective insulation materials used in housing applications. The metal layer is modified to insulate enclosures without blocking cellular communications and the protective functional layer in modified to minimize emissivity, create a hydrophobic and/or oleophobic surface, and/or prevent mold, fungi and bacteria growth. Solutions are provided to solve occupational-hazard problems associated with the use of these materials in enclosures that include power wires.

### RELATED APPLICATIONS

This application is a continuation-in-part application of U.S. Ser. No. 12/250,083, filed Oct. 13, 2008.

### BACKGROUND OF THE INVENTION

1. Field of the Invention

This invention is related in general to heat-reflective barriers used for insulation purposes. In particular, the invention relates to low-emissivity multilayer structures with high resistance to environmental degradation. Substrates may be in the form of flexible films, polymer and inorganic composites, cellulose composites, non-woven polymers, vapor-transmitting and water-blocking films, micro-porous membranes, woven textiles, knitted textiles or some combination of these substrates. Low-emissivity multilayer structures may in turn be attached to other substrates that have among other properties a capacity to provide heat insulation. Superior environmental protection of the low-emissivity surface is accomplished by replacing conventional metallization and lacquer coatings used in the prior art with a series of pinhole-free functional polymer layers, metal and metal oxide layers formed in vacuum in-line with the metal deposition process. Additional functionality of the radiant barrier structures beyond heat reflection is derived by modifying both the functionality of the polymer layers as well as the structure of the metal layers.

2. Description of the Related Art

Metallized films and aluminum foils used to reflect heat are referred to herein as radiant barriers. When laminated to a material that has additional R-value, such as a bubble pack or a foam, such combined structures are commonly referred to as reflective insulation. Both terms are used interchangeably herein because the invention is directed to multilayer structures that produce reflection of radiation and low-emissivity surfaces that exists both in radiant barriers and in reflective insulation. The term “metallized,” as contrasted to “foil,” is used in the industry to refer to vacuum-deposited metal layers, as opposed to bulk metal foils. Furthermore, in the prior art the term “metallized,” as it relates to radiant barrier, means the deposition of a metal layer such as aluminum on a substrate that is brought into air for further processing (e.g., the deposition of a lacquer coating). In this invention the term “metallized” or “metallization” means only the deposition of the metal on a substrate because any additional steps are included before the substrate is taken out of the vacuum, which radically changes the properties of the metal layer. Therefore, the term metallized as used in the prior art represents a distinctly different structure than that of this invention.

Among various applications, radiant barriers are used to reflect heat into or away from building structures. Many of these barriers consist of metallized films in combination with foams, bubble packs, and non-woven synthetic materials. The aluminum metallized films that are of specific interest for this invention are intended to replace in many building applications aluminum metal foil in order to pass standards such as ASTM C727, ASTM C1224, BS 476 and ASTM E84. Because of the thickness of the aluminum foil, the aluminum layer tends to retain its integrity under fire and to allow a flame started along the backing of the foil to spread over adjacent combustible areas. Metallized films, unlike metal foils, melt and pull back from the initial fire point (see U.S. Pat. No. 5,108,821). Metallized Class A radiant-barrier products have been used in housing applications for almost three decades. For example, the product marketed as Parsec Thermo Brite® has been in existence since 1984. U.S. Pat. No. 7,935,411 describes such a composite metal-film structure.

Although metallized polyesters with foam backing pass flammability propagation tests, in 2000 the Federal Aviation Administration banned the use of all metallized thermoplastic films for aircraft applications (FAA 2000-7909) because they failed in actual fuselage applications, causing fatal in-flight fires. As a result, for aircraft applications metallized polyethylene terephthalate (PET) has been replaced mostly with metallized polyimide, which does melt back like most thermoplastic films but does not readily burn, nor propagate a flame.

Other applications of metallized barrier materials include thermal containers, emergency shelters and blankets, window coverings, industrial textiles and apparel with heat management properties. The use of aluminum metallized radiant-barrier materials in applications of extreme environmental conditions and/or applications that require product life of 15 years or more impose certain performance requirements. Specifically, metallized films need to have adequate protection from abrasion damage during handling and installation, corrosion resistance when exposed to various environments of humidity and temperature and in some cases resistance to bacteria, fungi and mold growth which, in addition to health-related issues, form a radiation-absorbing coating that reduces the efficiency of the radiant barrier.

In conventional metallized-film barrier applications, the aluminum layer is protected by the application of a thin layer of clear lacquer that has a thickness of up to about 0.5 microns. Thicker coatings increase the emissivity and much thinner coatings compromise environmental protection. Such lacquer coatings involve the use of high molecular weight polymers (MW>50,000) in a solvent (or aqueous solutions) applied by various conventional coating methods. In order to form such thin lacquer coatings, the lacquer solution has to contain a relatively low percent of solids. This leads to thickness non-uniformities and pinholes as the solvent dries. More recently, protective coatings have also been applied with UV-cured 100%-solid polymers that are roll coated onto the metallized layer. However, such coatings are also subject to thickness non-uniformities and pinholes because it is difficult to form thin-film coatings by conventional coating methods using 100% solids.

In addition to corrosion-related shortcomings of lacquer coatings, another problem is that the lacquer is applied after exposure of the metallized surface to atmospheric conditions. As described in U.S. Pat. No. 7,807,232, aluminum-metallized layers when exposed to atmosphere form a hydrated aluminum oxide (Al₂O₃.H₂O) that has inferior corrosion resistance properties than Al₂O₃. Therefore, the corrosion protection of the aluminum layer is compromised prior to the application of the clear lacquer layer.

The state of the art as it relates to low-emissivity surfaces is more closely aligned to techniques and methods used to produce metallized packaging films that are not subject to the durability and life requirements of most radiant-barrier materials. Therefore, it provides no teaching relevant to these problems.

This invention is directed to replacing metallization and lacquer with multilayer structures that maximize the resistance of radiant barriers to environmental degradation. Furthermore, additional functionality is added to the radiant barrier materials by changing the physical and chemical properties of the multilayer structure. The new radiant-barrier structures can be deposited on any substrate and do not affect the physical properties of the substrate on which they are deposited. For example, a multilayer radiant-barrier structure according to the invention may be deposited on polyethylene film that is subsequently laminated to bubble-pack insulation for use in a building application to pass Class A fire rating (ASTM E8), or on a polyimide film with foam insulation to pass the FAA-2000-7909 flammability test. In the former case the polyethylene film melts back to prevent the spreading of fire and in the latter case the polyimide film does not burn back. According to this invention, the surface of these films is modified in a manner that maximizes the radiant-barrier performance without affecting or compromising the substrate material properties.

The invention is described primarily with reference to metallized aluminum because it is the preferred metal for the applications covered by this disclosure, but it can be practiced in similar manner with other metals, such as tin, copper, zinc, silver, and with alloys and transparent and conducting metal oxides.

### BRIEF SUMMARY OF THE INVENTION

In view of the foregoing, this invention is directed to the production of metallized radiant barrier materials with low emissivities, improved resistance of the emissive surface to environmental degradation, and chemical and electrical functionality of the barrier structure. All insulation applications, ranging from building insulation to apparel with heat management properties, are intended to be covered.

According to one aspect of the invention, conventional lacquer coatings are replaced with functional polymer coatings that are pinhole-free and have a chemistry and thickness uniformity that is tailored to minimize absorption of infrared radiation. This is achieved by replacing lacquer coatings with polymer coatings formed in the vacuum in-line with the metallization process, using a molecular vapor-deposition method that eliminates pinholes and creates coatings with a high degree of thickness uniformity. The polymer layers are formed by evaporating monomer materials with specific chemistry, condensing them onto a substrate, and cross-linking them using electron-beam radiation. Such polymer coatings have been used (see U.S. Pat. No. 6,092,269) as submicron polymer dielectrics for multilayer capacitor structures (usually more than 4000 aluminum/polymer layers) where a single pinhole in one polymer layer would lead to capacitor failure. The low-emissivity film for insulation applications is preferably manufactured, according to the invention, entirely in vacuum.

According to another aspect of the invention, the metal layer, in particular aluminum, is preferably exposed to an oxygen-plasma-induced passivating step in vacuum, immediately after deposition, to improve its corrosion resistance. In conventional radiant-barrier metallization processes, the substrate film is metallized in a vacuum chamber and then unwound under atmospheric conditions to be slit and coated with a lacquer. Exposure of the freshly metallized aluminum to air that contains both oxygen and moisture leads to the formation of hydrated aluminum oxides with poor corrosion resistance. In the invention, the corrosion resistance of the aluminum layer is maximized by forming a pure Al₂O₃ barrier layer on the metal surface. Unlike hydrated aluminum oxide, which may exhibit various degrees of corrosion resistance based on the ambient level of humidity when the metallized layer is taken out of the vacuum chamber, the in-situ-formed aluminum oxide of the invention is uniform, non-porous and corrosion resistant. Therefore, the pinhole-free protective polymer coating is combined with the formation of a high quality Al₂O₃-barrier layer to protect the aluminum radiant-barrier layer from corrosion-related degradation.

According to yet another aspect of the invention, a leveling polymeric layer may be deposited between the substrate and the aluminum layer in order to improve the corrosion resistance of the metallized aluminum layer as well as its mechanical integrity. When an aluminum layer is deposited on various substrates, the measured emissivity value reflects the average aluminum thickness and continuity of the aluminum layer across the substrate. Low emissivity values are obtained with flat and level polymer film substrates, while higher values result from materials that have high surface micro-roughness and discontinuous surfaces, such as woven and woven substrates. We found that when polymer-film substrates such as polyethylene, polypropylene and polyester are metallized, even with low emissivity values of ∈=0.03 to ∈=0.04, the metallized layer has a large number of microscopic pinholes, the density of which can vary dramatically from one polymer film to another based on their surface roughness. The pinholes are usually located on the peak of film fibral features that protrude above the film surface and overheat during the metal deposition, as well as at the top of additives that bloom onto the film surface (antioxidants and slip agents). The pinholes represent areas where corrosion sites can initiate during the life of the product. Furthermore, the metallized layer around a feature that protrudes above the film surface has a significantly lower thickness (and higher emissivity) than the average aluminum thickness. This, combined with the presence of a pinhole, will accelerate the corrosion of the aluminum layer and lead to high levels of degradation over the life of the product. We found that a leveling polymer coating deposited on the substrate surface has several benefits that contribute to the quality and performance stability of the metallized aluminum layer. Specifically, it reduces the level of micro-roughness, which improves the thickness uniformity of the metal layer. Also, the electron-beam cross-polymerized layer has superior thermomechanical properties than the substrate resulting in a lower number of pinholes. Finally, the leveling layer produces greater adhesion of the metallized aluminum, which in turn minimizes delamination and microcracking, all of which lead to loss of performance.

According to another aspect of the invention, a non-specular durable and high-performance radiant-barrier structure is produced that eliminates occupational hazard issues that can result both during the installation as well as the operation of such specular radiant-barrier material due to the reflection of bright light from its surface, which can temporarily blind an installer or operator. A polymer coating that has a diffuse surface in the visible spectrum is deposited on the substrate. When metallized, this type of surface results in a hazy metallic layer that is void of specular metallic glint. In fact in same cases the surface texture can be controlled to produce a subtle color shift which is attractive and pleasing to the eye. A key part of this invention is the creation a surface that eliminates the metallic without significantly changing the emissivity value.

Yet another aspect of this invention lies in the formation of a radiant-barrier structure that has the lowest possible emissivity with a high level of corrosion resistance. The protective functional polymer coating, when optimized for performance that combines a certain level of abrasion resistance with corrosion resistance, may have a thickness of about 0.2-0.5 micrometers which, depending on the polymer chemistry, can add 0.005 to 0.02 to the emissivity of the metal surface. For applications that require an emissivity level substantially equal to that of the metal surface, as well as environmental protection, the aluminum surface can be protected by two extremely thin layers with no measurable absorption. One layer is provided by the oxygen-plasma-induced barrier-oxide layer and the other is a highly hydrophobic and/or oleophobic molecular layer deposited on the oxide layer using a high-speed molecular self-assembly process. This barrier structure has a measured emissivity value equal to that of the metal surface and virtually the same corrosion resistance as that of the protective functional polymer layer.

Another aspect of the invention relates to the use of multilayer radiant-barrier structures in textile and apparel applications for heat management. In such applications the multilayer barrier structure may be deposited on various substrates including a fabric or a membrane or a film that blocks water but transmits vapor. In order to avoid direct contact of the radiant barrier with the skin or another fabric layer, which can increase thermal transfer and reduce radiative efficiency, a low-density cover of fibrous material is used in contact with the protective functional layer of the radiant barrier so that only a fraction of the barrier structure is contacted. The fibrous material may continuous or have holes, which further minimizes contact with the barrier layer. Alternatively a non-fibrous material with holes may be used.

Another aspect of this invention is the superposition of chemistry on the protective functional layer that reduces or eliminates growth of bacteria, mold, fungi as well as other contaminants such as fingerprints during the installation process. Radiant barrier material used in environments of high temperature and humidity can grow bacteria, mold and fungi that will eventually add an absorbing layer that reduces radiant-barrier performance. The chemistry of the protective functional layer is formulated to resist bacteria growth as well as produce hydrophobic and oleophobic functionality to minimize wetting of the functional polymer layer.

Yet another aspect of the invention is the formation of a barrier structure that has an electrical functionality. Specifically, given their low emissivity, most radiant-barrier materials used in housing applications are composed of a continuous metal layer that is electrically conductive. This creates two different problems: a) the radiant barrier (or reflective insulation) when placed in the attic and walls of a structure can inhibit cellular communications by blocking the RF signals; and b) during installation or at some point during the life of the a radiant barrier product, the metallized surface can come into contact with an exposed power cable (live wire), which can cause electric shock or start a fire. We found that one method to resolve both of these problems is to segment the metallized layer into small sections that prevent conduction along the radiant-barrier sheet and allow RF frequencies to transmit through the barrier. Another approach that resolves only the second problem is to control the thickness of the metal layer so that it has “self-healing” or “clearing” properties. Both of these terms are commonly used in the metallized capacitor industry to describe the ability of a capacitor comprising metallized electrodes and a polymer film dielectric to recover from an electrical short by a process where the thin metal electrode melts away from the location of the short, much like a fuse (see A. Yializis, Handbook of Solid State Batteries & Capacitors, Edited by M. Z. A. Munshi, World Scientific, 1995). The radiant barrier self-healing process is different from that of metallized film capacitors, but it can be equally effective in preventing an electric shock or a fire.

The combination of the above-described elements into different radiant-barrier structures produced in-line in a vacuum chamber results in unique low-emissivity surfaces with superior durability that will vary in functionality based on the nature of the application and the substrate (film, non-woven, etc). Although these new radiant barrier structures are physically different from the conventional metallized film and clear lacquer coatings taught in the prior art, we found that the relatively low thickness of the various protective functional layers do not alter the physical characteristics that are substrate dependent, including volume, weight, permeability (this depends on the substrate porosity level), and performance, under various flammability tests such as the ASTM E84-94, FAA-2000-7909, UL94 VO and CPSC 16 CFR Part 1610.

Various other purposes and advantages of the invention will become clear from its description in the specification that follows and from the novel features particularly pointed out in the appended claims. Therefore, the invention consists of the features hereinafter illustrated in the drawings, fully described in the detailed description of the preferred embodiments and particularly pointed out in the claims.

### BRIEF DESCRIPTION OF THE DRAWINGS

FIG. 1 is a schematic representation of a basic form of the thermal radiant-barrier structure taught by this invention, including a substrate, an oxygen-rich layer, a metal layer, a passivating oxide layer and a protective functional polymer layer.

FIG. 2 illustrates how a substrate with various levels of micro-roughness can affect the thickness of the metal layer, which in turn affects both the emissivity of the surface and the corrosion resistance of the metal layer.

FIG. 3 is a schematic of a thermal barrier structure which includes a leveling polymer layer, a protective oxide and a protective functional polymer layer.

FIG. 4 is a histogram showing the amount of holes formed on a deposited metal layer with and without leveling layer and protective functional polymer layer.

FIG. 5 is a schematic representation of a thermal radiant-barrier structure, as taught by this invention, formed on a substrate that is attached onto another insulating layer.

FIG. 6 is a schematic representation of a thermal radiant-barrier structure for a textile application, where a fibrous layer with apertures in the form of holes is attached to the protective polymer layer, thus allowing a significant portion of the radiant barrier to function without contact with another surface.

FIG. 7 is a schematic representation of a radiant barrier structure that has maximum reflectivity (minimum emissivity) produced by replacing the protective functional polymer layer with a self assembled molecular layer that is hydrophobic and oleophobic.

FIG. 8 shows a scanning electron microscope photo and an atomic force microscope analysis of a textured substrate used to eliminate metallic glint.

FIG. 9 is a schematic illustration of different patterns that can be used to segment a metallized radiant barrier to transmit cellular communications as well create electrical isolation.

### DETAIL DESCRIPTION OF THE INVENTION

The invention is based primarily on the formation of multilayer radiant-barrier structures designed for low emissivity and long-term protection of the radiant barrier from environmental degradation. These barrier structures can be further configured chemically and physically to acquire other unique properties such as include anti-mold and RF-transmission properties to facilitate cellular communications and electrical isolation.

In general, when a polymeric film is metallized with aluminum or an aluminum alloy in vacuum, the roll of metallized film is removed from the vacuum chamber and processed in air in various ways, thereby allowing the formation of a protective aluminum-oxide layer. However, given the fact that air contains a significant level of humidity that can vary seasonally and from location to location, a hydrated aluminum oxide [Al₂O₃.(H₂O)ₙ] is formed, which is structurally inferior to Al₂O₃. Although this relatively poor level of protection has no effect in the measured emissivity values of the metallized layer, its long-term performance is compromised.

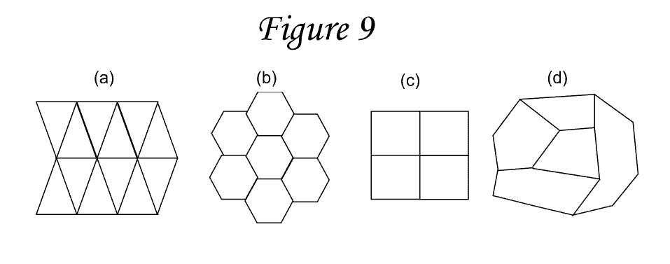

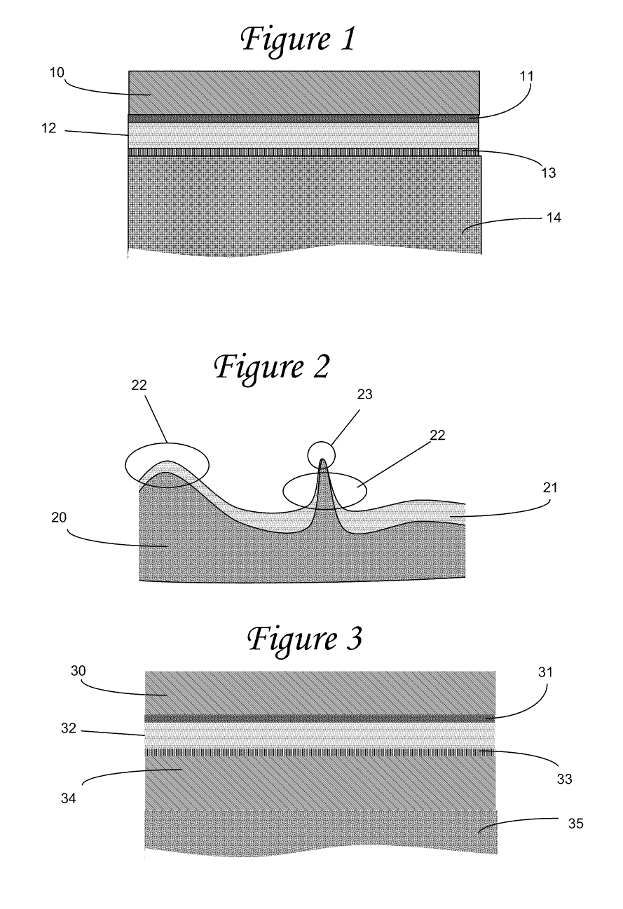

Until recently, metallized layers for various applications have been produced with little understanding about the effects of hydrated aluminum oxides on the stability of the aluminum layer. In addition to the formation of hydrated aluminum oxide by exposure to air, we found that many substrate materials over which the aluminum is deposited retain a certain level of moisture even in vacuum. When the deposited aluminum, which is highly reactive in its metallic state, is wound into a roll in the vacuum chamber, it starts to react on both surfaces with such retained moisture before the roll is unwound in the air. Therefore, in order to improve the corrosion resistance of the deposited aluminum layer, it is necessary to reduce or eliminate the formation of hydrated aluminum oxide on both surfaces of the deposited layer. As shown in FIG. 1, layer 11 is a high-quality barrier aluminum-oxide layer formed by exposing the deposited aluminum layer 12 to an oxygen plasma. 100% oxygen is the preferred plasma gas for forming such Al₂O₃ layer on the surface of the aluminum, although other plasma gas mixtures with a lesser amount of oxygen can also been used effectively by increasing the plasma power level. Layer 12 represents pure aluminum metal and layer 13 is an additional oxygen-rich layer formed on the substrate 14 by exposure of the substrate to an oxygen-containing plasma. The preferred plasma gas used in treating the substrate 14 is an 80%/20% Ar/O2 mixture. Although many different gas mixtures can be used for this process, we found that the presence of the heavy Ar atoms helps to ablate the substrate surface, thereby removing contaminants such as low molecular weight organics and adsorbed moisture. The aim in this process step is to remove moisture and form an oxygen-rich layer which also promotes bonding of the aluminum layers with the substrate layer.

### Example 1

A polyethylene substrate 100″ wide was metallized with aluminum at 1500 ft/min. The substrate was plasma treated prior to the metallization with 10 KW of 80%/20% Ar/O2 plasma using an inverted magnetron hollow cathode plasma reactor manufactured by Sigma Technologies. An aluminum layer with an optical density of OD=3.1 was deposited on the treated substrate and some of the metal was treated with 8 KW of O₂ plasma and some was not. After the roll of film was removed from the vacuum chamber, the emissivity of the metal layer was ∈=0.035. There was no significant difference in emissivity values between sections of the metallized film that were oxygen-treated on the surface and sections that were not. The two metallized films were exposed to a temperature/humidity test at 40 C/90RH for a period of 100 hrs. After the test the emissivity of the untreated metal was 0.15 and that of the oxygen plasma-treated metal was 0.06.

The corrosion resistance of aluminum is also a function of aluminum thickness. In general, the thicker the aluminum layer the higher the corrosion resistance. However, given that most metallized radiant-barrier materials are produced at high speed (1000 ft/min to 3000 ft/min), it is difficult and impractical to deposit very thick aluminum layers. Table 1 shows the relationship between metallized aluminum optical density, thickness and emissivity, as well as resistance of such aluminum layers to corrosion.

TABLE 1
Corrosion resistance of aluminum metallized films with
different metal thickness without a barrier oxide layer and
a protective functional polymer layer.

| Approximate | | | Emissivity |
|---|---|---|---|
| Thickness | | Optical | After 3 min of |
| (nm) | Emissivity | Density | Steam Test |
| 4 | 0.105 | 0.9 | Full Corrosion |
| 10 | 0.05 | 1.7 | Full Corrosion |
| 13 | 0.038 | 2.1 | Most Al Corroded |
| 20 | 0.035 | 2.7 | Some Corrosion |
| 50 | 0.029 | 4.0 | 0.08 |

According to the invention, a protective functional layer for the metallized film is also formed in-line with the aluminum oxidation process using a molecular vapor deposition process. As shown in FIG. 1, layer 10 represents the protective functional polymer layer deposited on the barrier oxide layer 11. The thickness and chemistry of the protective functional layer are selected so as to minimize absorption at the infrared wavelengths of interest, thereby minimizing emissivity and maximizing the efficiency of the radiant barrier. A preferred process for the deposition of the protective functional layer is flash evaporation of an acrylate monomer formulation (consisting of one or more acrylate monomer chemistries), which converts the liquid monomer into a molecular vapor that is deposited via a linear nozzle onto the freshly produced oxide layer, leading to the formation of adhesion-promoting covalent bonds between the oxide layer and the condensed liquid monomer layer. It should be noted that the polymer layer may be deposited in vacuum by other techniques, such as roll coating and radiation curing, sublimation, and plasma polymerization.

### Example 2

The effect of the thickness of the vacuum deposited functional polymer layer on the emissivity of the metallized aluminum was tested. A 60/20/20% mixture of glycol diacrylate/acid ester triacrylate/triazin triacrylate monomers was flash evaporated and electron-beam cross linked on a metallized PET film with an OD=3.5. Table 2 shows the emissivity values as a function of the polymer thickness.

TABLE 2
Emissivity as a function of
protective functional layer thickness

| Polymer Thickness | Emissivity |
|---|---|
| 0.25 micron | 0.035 |
| 0.30 micron | 0.040 |
| 0.73 micron | 0.065 |

The flatness and smoothness of the substrate on which the metal layer is deposited can have a significant effect both on the initial emissivity values as well as the stability of the emissivity over the life of the product. FIG. 2 shows a schematic representation of a metallized layer 21 deposited on a substrate 20 that has various levels of surface micro-roughness. Surface features such as illustrated in areas 22 have lower-thickness metal than flatter areas. Furthermore, we found that on relatively sharp surface features, such as illustrated in area 23, the aluminum is missing, thereby creating a pinhole. Such sharp features are present on most substrate materials, including common polymer film substrates such as polyester (PET), polyethylene (PE) and polypropylene (PP). The pinholes may be generated during the metallization process or in subsequent processing due to abrasion with rollers and rewinding of the film into a roll under tension. The pinholes form predominantly on select surface features that include:

a) polymer fibral features that protrude above the film surface. Such fibral features are mostly a function of the resin and the process used to form the polymer film. They have distinct shapes that vary from manufacturer to manufacturer in shape, size, degree of protrusion above the film surface and often also in physical and chemical properties. Such polymer protrusions have relatively low thermal conductivity, which causes them to soften up and often melt when metallized, thus producing a pinhole in the metal layer.

b) Additives such as slip agents and antioxidants, which may be both organic and inorganic compounds. Many such inclusions are forced onto the film surface (blooming effect) as the polymer resin is processed into a film. Polymer additives behave much like polymer fibral features. In addition to pinholes created by metal abrasion, in some cases emission of gas and moisture trapped around an additive will divert metal atoms, which also leads to the formation of a pinhole.

The thickness variation of the metal layers around surface features and the presence of pinholes accelerate the corrosion of the metal layer under various conditions of temperature and humidity. Observation of incipient corrosion sites clearly shows that most corrosion sites are associated with a surface feature or a pinhole.

Therefore, in addition to the protective functional polymer layer, which has a significant impact on pinhole generation, we found that the initial emissivity of a micro-rough substrate and its stability in an accelerated corrosion test can be improved by also applying a leveling coat in vacuum prior to the deposition of the metal layer. The process used to deposit the leveling layer is the same as that used to deposit the protective functional polymer layer. FIG. 3 shows a schematic of a substrate 35 coated with such a leveling coat 34. The thickness of the leveling coat varies with the level of surface roughness and can be anywhere from 0.1 to 1.0+ microns thick. An oxygen-rich layer 33 is created on the leveling coat 34 using an oxygen plasma treatment. The metal layer 32 is deposited on the oxygen-rich layer 33 followed by the formation of the barrier aluminum oxide layer 31 and the protective functional polymer layer 30.

### Example 3

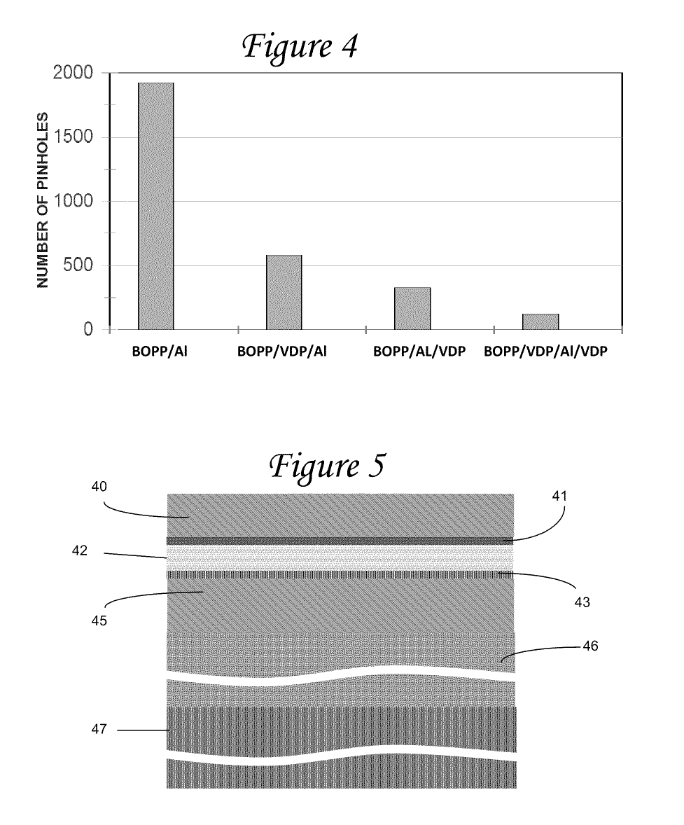

The effect of pinhole reduction using protective and leveling polymer layers is shown in FIG. 4. BOPP stands for Biaxially Oriented Polypropylene, VDP for Vapor Deposited Polymer and Al for metallized aluminum. Biaxially oriented polypropylene film was metallized with aluminum with an optical density OD=2.5. The number of pinholes per unit area was measured with an optical microscope at 50× magnification. Some of the film was coated with a 0.25-micron leveling polymer layer of a cross-linked hexane diol diacrylate monomer deposited prior to the metal deposition. Some of the film also had a 0.25-microns of protective polymer after the metal deposition. FIG. 4 shows the pinhole count under different conditions. Although the undercoat had a significant effect (BOPP/VDP/Al) in the pinhole reduction, the protective functional coating had a larger effect (BOPP/Al/VDP). This suggests that that many of the pinholes are generated by abrasion of the thin aluminum from the top of the various surface non-uniformities as the film passes over various rollers, including rewinding in vacuum and unwinding in air. FIG. 4 shows that the best protection is provided when the aluminum is sandwiched between the two polymer layers. Furthermore, if the functional protective layer were to be replaced with a conventional lacquer coating, the pinholes eliminated by the deposition of the polymer layer in vacuum would be present and perhaps the number would increased because the lacquer process requires coating the metal layer in a separate piece of equipment. It should also be noted that the presence of pinholes in the metal layer does not suggest that there are pinholes in the polymer layer, but simply that the vacuum-deposited functional polymer layer is not thick enough to prevent complete pinhole formation from surface abrasion.

### Example 4

This Example shows the effect of corrosion protection of a radiant barrier material using the complete multilayer stack of the invention. A woven polyethylene material, 96″ wide, coated on both sides with a PE coating, was used as the substrate material. The polymer composite, which has both fabric and film-like properties, was processed at 1500 ft/min. A propoxylated ethylene diacrylate monomer layer 0.35 microns thick was deposited on the polyethylene surface and was cross-linked using an electron-beam curtain. An oxygen-rich layer was created on the surface of the leveling polymer using a 10 kW 80/20% Ar/O₂ plasma in an inverted magnetron hollow cathode reactor. The aluminum layer was then deposited on the oxygen-rich layer. The metallized aluminum layer was oxidized to form a barrier aluminum-oxide layer using 10 kW 80/20% Ar/O₂ plasma, followed by the deposition of a 0.25 micron thick functional protective polymer layer of the same chemistry as the leveling layer. When removed from the vacuum chamber, the metallized aluminum had an optical density OD=3.2 and emissivity ∈=0.045. The process was repeated on the other side of the PE composite and the radiant barrier material was exposed to a steam test for 90 minutes. At the end of the test the emissivity of the radiant barrier was 0.07.

### Example 5

The radiant-barrier material produced according to Example 4 was submitted to TexTest labs in Valley, Ala., for flammability tests. The radiant-barrier material passed the California 117 Section E flammability test with no ignition, which classifies it for a Class 1 fire rating. The same material also passed Flammability Test 16 CFR 1610 with no ignition, which also classifies it for a Class 1 rating. The same material also passed Flammability Test 16 CFR 1632.6 for a Class B classification.

The multilayer radiant-barrier structure described in this invention has no significant effect on the flammability of the substrate. The complete structure of leveling-layer/rich-oxygen-layer/aluminum/barrier-oxide/protective-coating has a total thickness less than 1 micron, which represents a small fraction of the substrate thickness. In fact such cross-liked vacuum-deposited coatings are less flammable than common substrates such as polyethylene and PET; in addition, they can be formulated to be fire retardant and fire extinguishing, although their combined thickness is too low to significantly retard the flammability of a relatively thick substrate material.

FIG. 5 illustrates schematically a reflective insulation structure according to the invention, comprising a protective functional layer 40 deposited on an aluminum-oxide barrier layer 41 formed on an aluminum layer 42, which is deposited on an oxygen-rich layer 43, that in turn is formed on a leveling layer 45 deposited on a substrate 45 that is attached to a material 47 that has additional insulation value. An additional layer 47 may be a foam, a bubble pack, a fabric, fiberglass, a cellulose containing layer, a sheet of plywood, a sheet of sheetrock, or any material that has thermal and/or acoustic insulating value. The layer 46 is preferably a flexible substrate material such as a polymer film, a polymer and inorganic composite, paper, a non-woven polymer, a micro-porous film that blocks water but transmits vapors, a membrane, a woven textile, a knitted textile, or some combination of these substrates

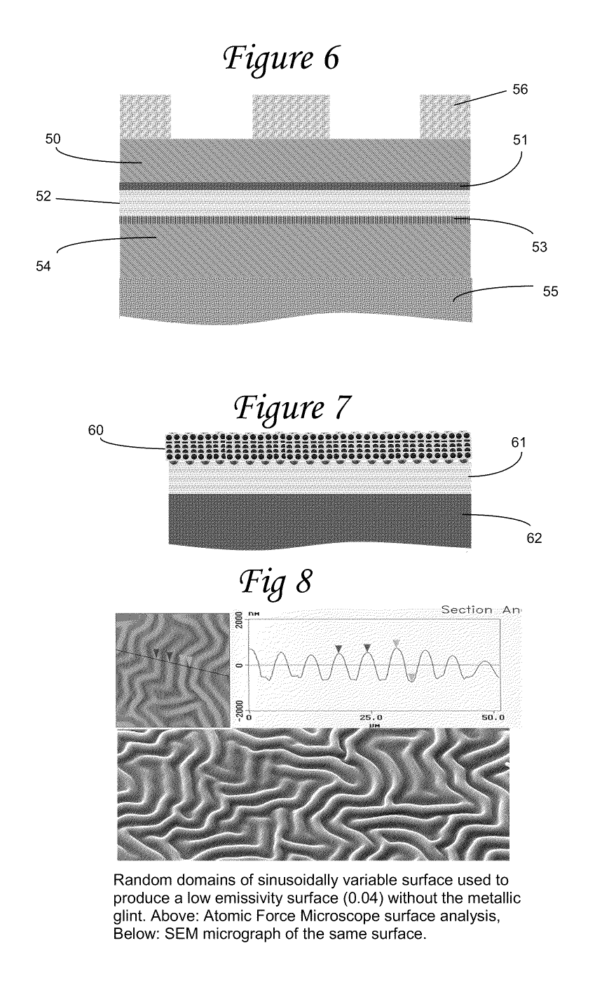

FIG. 6 shows a radiant-barrier structure suitable for use in apparel for heat management. A substrate 55 can be a fabric, a film, or a microporous membrane that transmits vapor but blocks water transmission. A leveling layer 54 may or may not be used, depending on the level of surface micro-roughness. An oxygen-rich layer 53 is formed as described on the surface of the leveling layer (or the substrate, is no leveling layer is used). An aluminum layer 52 is deposited on the oxygen-rich layer, followed by a barrier-oxide layer 51 and a protective functional polymer layer 50, as described above. In an apparel application, this heat-management structure may be used as is or by attaching the substrate 55 onto a fabric layer for added strength. The low-emissivity surface of this structure can be used facing an object (a person, body, limb, etc) the temperature of which needs to be managed, or for added comfort or insulation it may be attached to another fabric layer. If it is attached to another fabric layer, we found that, in order for the radiant barrier to function efficiently, the fabric has to have a low-density fiber structure to minimize contact with the radiant barrier and to allow the barrier to reflect radiation through the fibers. Alternatively, we found that a higher efficiency may be achieved by attaching a fibrous or non-fibrous material with holes (layer 56) to the protective functional layer 50.

### Example 6

The structure of FIG. 6 was formed using a micro-porous polypropylene film layer that transmits vapor but blocks water. A 60″ wide web of this material moving at 750 ft/min was coated with a leveling layer of a propoxylated glycol diacrylate, 0.3-micron thick. The leveling layer was plasma treated with 5 KW of 80%/20% Ar/O₂ to form an oxygen-rich layer. An aluminum layer was deposited on the oxygen-rich layer followed by a barrier oxide layer formed using 8 KW of 80%/20% Ar/O₂ plasma. A protective functional polymer layer with a thickness of 0.25 micron was deposited on the barrier oxide layer using the same polymer chemistry as the leveling layer. Measurements produced an aluminum optical density of 3.1 and an emissivity of 0.07. When the low-emissivity surface was attached to a continuous fibrous layer of polypropylene (low density fabric—visually semitransparent), the emissivity increased to 0.55. A similar fabric with a high density of ¼″ holes resulted in an emissivity of 0.3. Other fabrics and hole-size combinations can result in yet lower emissivity values.

FIG. 7 shows a schematic figure of a radiant-barrier structure that produces minimum emissivity (or maximum reflectance). In fact, the emissivity is the same as that of the metallized surface, which is not possible when a functional polymer coating is used to protect the metal layer. The basic radiant-barrier multilayer structure is the same, with the exception that the pinhole-free protective functional layer is replaced with a pinhole-free self-assembled molecular layer 60 deposited on the barrier aluminum-oxide layer 61 that is formed on the aluminum layer 62. As described in co-owned U.S. Application Ser. No. 13/007,639, self-assembly is a term used in various disciplines to describe processes in which a disordered system of pre-existing components forms an organized structure or pattern as a consequence of specific, local interactions among the components themselves, without external direction. When the constitutive components are molecules, the process is also termed molecular self-assembly. Depending on the monomer chemistry, the process can be used to create functional surfaces with different chemical properties, including low surface energy used to repel liquids such as water and organics and high surface energy used to enhance wettability.

Thus, using such process of self-assembly, a super hydrophobic and/or oleophobic fluoro molecular layer may be deposited on the aluminum surface such that the molecular layer provides very high corrosion resistance. This structure is useful in applications that require maximum reflectance, or where a protective polymer coating may interfere with the porosity of a substrate. Furthermore, in fabric applications where the apparel has to be washed, such molecular layer can have higher resistance to degradation than a coating.

### Example 7

A PET film was processed roll-to-roll in a vacuum chamber. The objective was to create a phobic surface on the metallized layer that can repel 100% Isopropyl Alcohol (IPA). A fluoro-containing monomer of perfluoro-hexyl-ethyl methacrylate was used for the self-assembly process. The PET film was approximately 35″ wide. The metallized surface substrate was exposed to a 3.5 kW Ar/O₂ plasma to form the barrier aluminum-oxide layer. The monomer was then injected into a flash evaporator and the generated vapor was directed onto the oxide layer at a web speed of 175 ft/min. Unlike the protective functional polymer layer, there is no curing involved with this process. The condensed monomer reacts with the freshly produced aluminum oxide and forms a pinhole-free self-assembled molecular layer that is highly phobic to water and oil. The metallized PET had an OD=3.5, emissivity ∈=0.03, and it repelled 100% IPA. When exposed to a steam test for 30 min, the emissivity was raised to 0.05.

A key property of a super-hydrophobic and oleophobic surface containing fluoro-functional groups is its resistance to mildew and fungi growth. Testing for fungi is conducted according to ASTM G21-96, which determines the resistance of synthetic polymeric materials to fungi growth. Various additives may be included, both in self-assembled coatings and in protective-polymer coatings, to make them hydro- and/or oleo-phobic using a monomer formulation containing Zonyl® compounds (Zonyl is a DuPont® product). In addition to such non-wetting surface properties, active antibacterial, antifungal and antimold additives can be readily incorporated in the self-assembled and protective-polymer coating. These include 2-octyl-2H-isothiazol-3-one; 4-amino-N-(5-methyl-3 isoxazoly)benzenesulfonamide; and butylated hydroxyanisole cyclic N-halamine derivatives, such as 1,3-dihalo-5,5-dimethylhydantoin and halogenated isocyanurates. Similarly, it is understood that the various functionalization steps described in related cases (see U.S. Pat. No. 7,157,117, for instance), can be used to modify the outer protective functional layer to suit particular needs.

According to another aspect, the invention is suitable for producing a radiant-barrier surface directed at eliminating occupational hazards associated with specular reflection of sunlight and bright lights that can temporarily blind an installer or an operator operating in the vicinity of installed radiant-barrier or reflective-insulation materials. Although a hazy surface will eliminate metallic glint, as described above, it will also affect the initial value of the emissivity and resistance to environmental degradation. The invention provides a structured surface that exhibits haziness without compromising its emissivity value. In order to achieve this result, it is important to have a surface with no abrupt changes in uniformity which, as explained earlier, can generate pinholes and significant variations in aluminum thickness. FIG. 8 shows an SEM micrograph of such a surface as well as a sectional analysis using an Atomic Force Microscope (AFM).

There are several ways of creating a structured surface with no abrupt changes in geometry (i.e., sharp angles), including conventional methods of cold or thermo-forming of the film surface or a coated film surface, and reverse printing with radiation-curable polymers. The preferred method for this invention is by depositing a structured polymer layer in vacuum prior to the deposition of the metal layer. A polymer layer similar to the leveling layer is deposited that is first partially polymered using radiation (low energy electron, UV, plasma, IR heat, heat of condensation from the aluminum layer, etc). The partial polymerization causes the surface to shrink and wrinkle as shown in FIG. 8. Depending on the thickness of this layer and the polymer chemistry, the visually diffusing wrinkled polymer layer may fully polymerize after the aluminum deposition, or additional exposure to higher energy electrons may be required prior to the deposition of the aluminum layer. By proper choice of the thickness of the leveling layer and the degree of cure, the height and period of the quasi-sinusoidal surface variation can be controlled. At a given amplitude and period, the metallized surface acquires a white pearlescent color that has low emissivity while maintaining an attractive appearance that is useful in applications such as walls and roofs of housing structures, or apparel, where the radiant barrier may be visible.

Another occupational-hazard problem associated with radiant barriers and reflective insulation is the potential for electrocution when a radiant barrier or reflective insulation is used to thermally insulate an object that is also connected to a power source, such as a building where the highly conductive metallized film can come in contact with a bare wire. Also a nail or staple that is used to fasten the radiant barrier (or reflective insulating barrier) sheet, can penetrate and make contact with a live wire. We found that, if the metallized conductive sheet is grounded, the metallized layer will self-heal and separate from a conductive element such as an exposed wire, a nail or a staple. During the self-healing process, the thin aluminum layer melts away from the conductor and opens the circuit, much like a fuse. This self-healing process is a function of voltage (which normally will be at least 110V AC, the current drawn, and the thickness of the metallized layer. We found that, unlike wound metallized film capacitors where metallized layers with a thickness of about 25 nm or less are required for an efficient self-healing process, the metallized radiant-barrier layer can self-heal effectively at thicknesses as high as about 50 nm. The reason for this is that, unlike capacitors where a self-healing site is somewhere in the middle of a wound roll and an arc can at some level of energy damage the adjacent layers (leading to a catastrophic failure), a radiant barrier sheet has at most two metallized layers and an arc can burn outward without affecting any other conductive layers. A self-healing event in this case means that the metal has melted away from a current-carrying conductor in a sub-second or so period, which opens the circuit and shuts down the arc, avoiding potential electrocution or fire. It should be noted that the above is applicable to metallized radiant barrier layers protected with a polymer layer that has a thickness less than about 1.0 microns. If the thickness of the protective functional polymer layer in much higher, then the polymer layer could provide adequate insulation to prevent an electrical short between a live wire and the metallized layer or a person contacting a radiant barrier that is electrified. On the low-thickness end of the metal layer, the self-healing process continues to improve inversely proportionally to the aluminum thickness, although through corrosion tests we found that 20 nm is a practical lower-thickness limit. Therefore, if a good ground connection to the radiant barrier or reflective insulation sheet is provided, the metallized layer will open the circuit around a current-carrying conductor even if there is no fuse or breaker in line with the short.

In addition to setting a limit of about 50 nm to the thickness of the metallized layer, we found another solution to the above described problem which is also a solution to the problem of RF communications signal blocking by the metallized radiant barrier. The solution to this dual problem lies in segmenting the metallization in the barrier sheet. To that end, the continuous metallized layer is de-metallized into small segments that allow the RF frequencies to penetrate through the segmented sheet with minimum impact on the emissivity of the metallized layer. Table 3 below shows the mobile communication frequencies that are in use in the US.

TABLE 3
Present and planned mobile communications bands

| Current/Planned Technologies | Band | Frequency (MHz) |
|---|---|---|
| SMR iDEN, ESMR CDMA (future) | 800 | 806-824 and 851-869 |
| AMPS, GSM, IS-95 (CDMA), | Cellular | 824-849 and 869-894 |
| IS-136 (D-AMPS), 3G | | |
| GSM, IS-95 (CDMA), | PCS | 1850-1910 and 1930-1990 |
| IS-136 (D-AMPS), 3G | | |
| 3G, 4G, MediaFlo, DVB-H | 700 MHz | 698-806 |
| Unknown | 1.4 GHz | 1392-1395 and 1432-1435 |
| 3G, 4G | AWS | 1710-1755 and 2110-2155 |
| 4G | BRS/EBS | 2496-2690 |

We found that, in order to effectively transmit a given frequency through a segmented conductive layer, the smaller the segment the lower the db loss of the signal. However, very small segments will result in high loss of reflectivity because the segmented non-metallized areas do not reflect heat. We found that the most effective method of segmenting the metallized sheet is to customize the segments to transmit the RF frequency of interest. For example, Table 1 shows that the 800 and cellular bands will be facilitated by a radiant barrier sheet that can transmit 900 MHz. This frequency corresponds to a wavelength L=33.3 cm. In order to effectively transmit through the segmented sheet, we found that the size of the segments should be of the order of a quarter wavelength or less, which is L/4=8.33 cm. At the other extreme, is order to facilitate 4 G communications at the BRS/EBS band, a 3 GHz transmission will be required for which L/4=2.5 cm. This is a much smaller segment, which can have a larger impact on the emissivity of the segmented layer if it is not properly demetallized.

FIG. 9 shows examples of different shapes that may be used to segment a metallized radiant barrier layer—geometric shapes (a) to (c) and random (d). Several different methods may be used to segment a metallized layer. These include mechanical cutting or scratching of the metal layer, laser ablation, chemical etching, and an inline process used in this invention where an oil pattern that mirrors the segmentation lines is printed onto the substrate prior to metallization. A combination of oil ablation during the metallization process and poor metal nucleation on the oil layer causes the aluminum to demetallize precisely where the oil is printed.

### Example 8

A segmented radiant barrier material was fabricated on 25-micron thick polyethylene film. A random segmentation pattern was chosen to avoid directional interference issues and polarization that can result from repeating geometric shapes. A mathematical relationship known as Voronoi Tessellation was used to calculate the size of the different segments. Limits were set on a maximum and a minimum segment size based on the targeted frequency. A computer program was used to form an image of a Voronoi Tessellation random demetallization pattern, which was transferred to the surface of a 40″ wide printing roller using a photolithographic technique. A Fomblin™ vacuum pump fluid that has low viscosity, low vapor pressure and low surface energy was used to print the pattern on the polyethylene film just prior to metallization. Several different patterns with segmentation lines of different width were printed. The precision of the printing and segmentation process was high at optical densities less than about OD=3.5. As the optical density increased, the resolution of the demetallized lines gradually degraded, which caused some lines to be partially demetallized, leading to electrical shorting from one segment to another. In order to avoid this effect, the line width had to be increased when the thickness of the metallization was high. The lowest line width that was achieved with this process was approximately 0.2 mm, which for an L/4 of 8.33 cm corresponds to less than 1% loss of reflection, or less than 1% increase in emissivity. It should be noted that, in addition to allowing transmission of cellular communications, the segmented metallized radiant barrier materials so produced virtually eliminate the probability of an arc or fire and dramatically reduce the probability of electrocution.

The invention may be practiced over a variety of substrates including, without limitation, polymer films (such as, polyesters, nylons, polyimides, polypropylenes, polyethylenes), paper, textiles, foams, woven and non-woven materials, inorganic fiber based materials such as fiberglass and carbon fiber based composites, membranes, and microporous films. Such substrates may be attached to insulating and or multifunctional materials such as foams, bubble pack, cellulose containing composites, polymeric and inorganic composites, plywood and sheetrock type materials.

This invention can utilize a broad range of organic monomers with various reactive moieties that can be used to form the leveling layer, the protective functional layer, and the self-assembled layer. A large variety of compounds can be used either as single monomers or in a formulation of one or more components.

These include:

1. Acrylate and methacrylate compounds with various degrees of functionality, e.g., mono-, di- and tri-acrylates and methacrylates. Such monomer molecules can be aliphatic, cyclo-aliphatic, aromatic, halogenated, metalated, etc.

2. Alcohols, such as allyl, methallyl, crotyl, 1-chloroallyl, 2-chloroallyl, cinnamyl, vinyl, methylvinyl, 1-phenallyl and butenyl alcohols; and esters of such alcohols with (i) saturated acids such as acetic, propionic, butyric, valeric, caproic and stearic, (ii) unsaturated acids such as acrylic, alpha-substituted acrylic (including alkylacrylic, e.g., methacrylic, ethylacrylic, propylacrylic, and the like, and arylacrylic such as phenylacrylic), crotonic, oleic, linoleic and linolenic; (iii) polybasic acids such as oxalic, malonic, succinic, glutaric, adipic, pimelic, suberic, azelaic and sebacic; (iv) unsaturated polybasic acids such as maleic, fumaric, citraconic, mesaconic, itaconic, methylenemalonic, acetylenedicarboxylic and aconitic; and (v) aromatic acids, e.g., benzoic, phenylacetic, phthalic, terephthalic and benzoylphthalic acids.

3. Acids and esters with lower saturated alcohols, such as methyl, ethyl, propyl, isopropyl, butyl, isobutyl, sec-butyl, tert-butyl, 2-ethylhexyl and cyclohexyl alcohols, and with saturated lower polyhydric alcohols such as ethylene glycol, propylene glycol, tetramethylene glycol, neopentyl glycol and trimethylolpropane.

4. Lower polyhydric alcohols, e.g., butenediol, and esters thereof with saturated and unsaturated aliphatic and aromatic, monobasic and polybasic acids, examples of which appear above.

5. Esters of the above-described unsaturated acids, especially acrylic and methacrylic acids, with higher molecular weight monohydroxy and polyhydroxy materials such as decyl alcohol, isodecyl alcohol, oleyl alcohol, stearyl alcohol, epoxy resins and polybutadiene-derived polyols.

6. Vinyl cyclic compounds including styrene, o-, m-, p-chlorostyrenes, bromostyrenes, fluorostyrenes, methylstyrenes, ethylstyrenes and cyanostyrenes; di-, tri-, and tetrachlorostyrenes, bromostyrenes, fluorostyrenes, methylstyrenes, ethylstyrenes, cyanostyrenes; vinylnapthalene, vinylcyclohexane, divinylbenzene, trivinylbenzene, allylbenzene, and heterocycles such as vinylfuran, vinylpridine, vinylbenzofuran, N-vinylcarbazole, N-vinylpyrrolidone and N-vinyloxazolidone.

7. Ethers such as methyl vinyl ether, ethyl vinyl ether, cyclohexyl vinyl ether, octyl vinyl ether, diallyl ether, ethyl methallyl ether and allyl ethyl ether.

8. Ketones, e.g., methyl vinyl ketone and ethyl vinyl ketone.

9. Amides, such as acrylamide, methacrylamide, N-methylacrylamide, N-phenylacrylamide, N-allylacrylamide, N-methylolacrylamide, N-allylcaprolatam, diacetone acrylamide, hydroxymetholated diacetone acrylamide and 2-acrylamido-2-methylpropanesulfonic acid.

10. Aliphatic hydrocarbons; for instance, ethylene, propylene, butenes, butadiene, isoprene, 2-chlorobutadiene and alpha-olefins in general.

11. Alkyl halides, e.g., vinyl fluoride, vinyl chloride, vinyl bromide, vinylidene chloride, vinylidene bromide, allyl chloride and allyl bromide.

12. Acid anhydrides, e.g., maleic, citraconic, itaconic, cis-4-cyclohexene-1,2-dicarboxylic and bicyclo(2.2.1)-5-heptene-2,3-dicarboxylic anhydrides.

13. Acid halides such as cinnamyl acrylyl, methacrylyl, crotonyl, oleyl and fumaryl chlorides or bromides.

14. Nitriles, e.g., acrylonitrile, methacrylonitrile and other substituted acrylonitriles.

15. Monomers with conjugated double bonds

16. Thiol monomers

17. Monomers with allylic double bonds

18. Monomers with epoxide groups and others.

While the invention has been shown and described herein in what is believed to be the most practical and preferred embodiments, it is recognized that departures can be made therefrom within the scope of the invention. For example, the invention has been described in terms of aluminum, but the various improvements described herein could be used with other reflective metals as well, such as tin, copper, zinc, silver, and transparent conductive materials such as IZO and ITO. Similarly, the invention has been described primarily in terms of depositing the polymer layers in vacuum by flash evaporation, which is preferred, but it is understood that any vacuum deposition process that allows fine control of the thickness of deposition of the coating may be used to practice the invention. Thus, the invention is not to be limited to the details disclosed herein but is to be accorded the full scope of the claims so as to embrace any and all equivalent processes and products.

We claim:

1. A thermal radiant barrier structure comprising:
a) a flexible substrate;
b) an oxygen-rich layer on the surface of the substrate;
c) a metal layer deposited in vacuum in-line on the oxygen-rich layer;
d) a metal-oxide layer formed on the metal layer as the metal layer is deposited in vacuum in-line; and
e) a protective functional polymer layer deposited in vacuum in-line on the metal-oxide layer.

2. The barrier structure of claim 1, wherein layers b) through e) are deposited on both sides of said substrate.

3. The barrier structure of claim 1, wherein the substrate includes a flexible material selected from the group consisting of a polymer film, a polymer and inorganic composite, paper, a non-woven polymer, a foam, a vapor-transmitting and water-blocking film, a micro-porous membrane, a woven textile, a knitted textile, or a combination thereof.

4. The barrier structure of claim 3, wherein the substrate is first coated with a leveling polymer layer.

5. The barrier structure of claim 1, wherein the substrate is further attached to one side of an insulating layer including an insulating material selected from the group consisting of foam, bubble pack, organic and inorganic fiber-based composites, cellulose-based composites, plywood, and sheet-rock.

6. The barrier structure of claim 1, wherein the substrate is further attached to both sides of an insulating layer including an insulating material selected from the group consisting of foam, bubble pack, organic and inorganic fiber-based composites, cellulose-based composites, plywood, and sheet-rock.

7. The barrier structure of claim 1, wherein the structure has a Class A fire rating.

8. The barrier structure of claim 1, wherein the structure is attached to one side of an insulating material that is a Class A fire-rated material.

9. The barrier structure of claim 8, wherein the structure is coupled to an object that requires a Class A fire rating.

10. The barrier structure of claim 7, wherein the structure is attached to both sides of an insulating material that is a Class A fire-rated material.

11. The barrier structure of claim 10, wherein the structure is coupled to an object that requires a Class A fire rating.

12. The barrier structure of claim 1, wherein said protective functional polymer layer is hydrophobic and oleophobic.

13. The barrier structure of claim 1, wherein said protective functional polymer layer is anti-mold, anti-fungi and antibacterial.

14. A thermal radiant barrier structure comprising:
a) a flexible substrate;
b) a leveling polymer layer;
c) an oxygen-rich layer on the surface of the leveling polymer layer;
d) a metal layer deposited in vacuum in-line on the oxygen-rich layer;
e) a metal-oxide layer formed on the metal layer as the metal layer is deposited in vacuum in-line; and
f) a protective functional polymer layer deposited in vacuum in-line on the metal-oxide layer.

15. The barrier structure of claim 14, wherein layers b) through f) are deposited on both sides of said substrate.

16. The barrier structure of claim 14, wherein the substrate includes a flexible material selected from the group consisting of a polymer film, a polymer and inorganic composite, paper, a non-woven polymer, a foam, a vapor-transmitting and water-blocking film, a micro-porous membrane, a woven textile, a knitted textile, or a combination thereof.

17. The barrier structure of claim 14, wherein the structure is attached to a material that has additional insulating value.

18. The barrier structure of claim 14, wherein the structure has a Class A fire rating.

19. The barrier structure of claim 18, wherein the structure is attached to one side of an insulating material that is a Class A fire-rated material.

20. The barrier structure of claim 18, wherein the structure is attached to both sides of an insulating material that is a Class A fire-rated material.

21. The barrier structure of claim 14, wherein the structure is coupled to an object that requires a Class A fire rating.

22. The barrier structure of claim 14, further comprising a cover material attached the functional polymer layer, said cover material being substantially transparent to radiation and being in contact with only a fraction of the protective functional polymer layer.

23. The barrier structure of claim 22, wherein said cover material is selected from the group consisting of a continuous fibrous material, a fibrous material with holes, and a non-fibrous material with holes.

24. A thermal radiant barrier structure comprising:
a) a flexible substrate;
b) a leveling polymer layer;
c) an oxygen-rich layer on the surface of the leveling polymer layer;
d) a metal layer deposited in vacuum in-line on the oxygen-rich layer;
e) a metal-oxide layer formed on the metal layer as the metal layer is deposited in vacuum in-line; and
f) a self-assembled molecular layer formed in vacuum in-line on the metal-oxide layer.

25. The barrier structure of claim 24, wherein layers b) through f) are deposited on both sides of said substrate.

26. The barrier structure of claim 24, wherein the substrate includes a flexible material selected from the group consisting of a polymer film, a polymer and inorganic composite, paper, a non-woven polymer, a foam, a vapor-transmitting and water-blocking film, a micro-porous membrane, a woven textile, a knitted textile, or a combination thereof.

27. A thermal radiant barrier structure with reduced metallic glint comprising:
a) a flexible substrate;
b) a patterned polymer layer formed on the substrate to diffuse visible radiation;
c) a metal layer deposited on said patterned polymer layer; and
d) a functional polymer layer deposited on said metal layer.

28. The barrier structure of claim 27, wherein layers b) through f) are deposited on both sides of said substrate.

29. The barrier structure of claim 27, wherein the substrate includes a flexible material selected from the group consisting of a polymer film, a polymer and inorganic composite, paper, a non-woven polymer, a foam, a vapor-transmitting and water-blocking film, a micro-porous membrane, a woven textile, a knitted textile, or a combination thereof.

30. The barrier structure of claim 27, wherein the structure has a Class A fire rating.

31. The barrier structure of claim 30, wherein the structure is attached to one side of an insulating material that is a Class A fire-rated material.

32. The barrier structure of claim 31, wherein the structure is coupled to an object that requires a Class A fire rating.

33. The barrier structure of claim 30, wherein the structure is attached to both sides of an insulating material that is a Class A fire-rated material.

34. The barrier structure of claim 33, wherein the structure is coupled to an object that requires a Class A fire rating.

35. A thermal radiant barrier structure comprising a flexible substrate, a metallized aluminum layer with a thickness of 20 nm to 50 nm deposited on said flexible substrate, a polymer layer with thickness less than 1 micron deposited on said metallized aluminum layer, said aluminum layer being self-healing when in contact with a high voltage electrical conductor.

36. The barrier structure of claim 35, wherein the barrier structure is used to thermally insulate a powered object.

37. The barrier structure of claim 35, wherein the metal layer is segmented to disrupt electrical current flow and allow transmission of RF signals.

38. The barrier structure of claim 35, wherein an outer surface thereof is anti-mold, anti-fungi and antibacterial.

39. The barrier structure of claim 35, wherein an outer surface thereof is hydrophobic and oleophobic.
